(19) United States
(12) Patent Application Publication
(10) Pub. No.: US 2006/0120084 A1
(43) Pub. Date: Jun. 8, 2006

(54) Light source device and projector

(75) Inventor: Yoshiaki Sueoka, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/288,692

(22) Filed: Nov. 29, 2005

(30) Foreign Application Priority Data
Dec. 2, 2004 (JP) 2004-349611

(51) Int. Cl. F21V 29/00

(52) U.S. Cl. 362/294

(57) ABSTRACT

A light source device and a projector having the light source device provide a light emission unit for radiating illuminating light L, a light emission control unit for controlling the amount of light of the illuminating beam L radiated by the light emission unit, a cooling unit for cooling the heat generated at the time the light emission unit radiates the illuminating light L, a cooling control unit for controlling the amount of heat cooled by the cooling unit, an operation unit capable of regulating a manipulated variable amount with respect to a prescribed controlled system, and a calculation unit for computing at least one of the controlled variables of the light emission control unit and the cooling control unit based on the manipulated variable regulated by the operation unit.

### PRIORITY CLAIM

Priority is claimed on Japanese Patent Application No. 2004-349611, filed on Dec. 2, 2004, the content of which is incorporated herein by reference.

### BACKGROUND OF THE INVENTION

1. Field of the Invention

The present invention relates to a light source device that radiates an illuminating beam and a projector containing the light source device.

2. Description of the Related Art

Conventionally, various types of projectors with different projection methods have been provided. As one example, a projection type of liquid crystal projector is known. This liquid crystal projector, generally, radiates light from a light source to a translucent liquid crystal panel, and by operating a liquid crystal panel based on an information signal from a personal computer signal or television signal, light modulated from the liquid crystal panel is radiated and a magnified image is projected to the screen through a projection lens.

At such a time, an extremely high luminance lamp is necessary as a light source; therefore, a high pressure mercury lamp or a plurality of LED's, for example, are used as a lamp.

However, due to heat generation from the lamp, the temperature within the projector rises causing an adverse effect due to heat. Further, the lamp itself is also adversely affected.

Therefore, projection display devices and liquid crystal display devices are known for countering the temperature rise within this type of projector. See, for example, Japanese Patent Publication 2003-15224 and Japanese Patent Publication 2000-352708.

The projection display device described above allows a user to freely select protective measures against a temperature rise when the temperature within the projector, in other words, the temperature around the lamp, exceeds a setting value. For example, when the temperature around the lamp exceeds the setting value, various modes are displayed on screen and the user can select protective measures. With such a display, the user selects a mode by operating a remote control or the like while recognizing that the temperature around the lamp has exceeded the setting value. Furthermore, the user can control the selected mode, for example, reducing the lamp luminance, increasing the rotation speed of a fan, or reducing the luminance of the lamp together with increasing the rotation speed of the fan according to a screen brightness priority mode, noise priority mode, and rapid cooling mode.

In this way, because protective measures against temperature rise can be selected, a user cannot only simply control the temperature rise within a projector, but it can also be selected according to the audio-visual environment.

Further, the liquid crystal display device described above detects the amount of light emission of a lamp through a sensor, and controls the revolutions of a cooling fan based on the detected results. More specifically, sensors for detecting various temperature changes in the vicinity of the lamp and liquid crystal panel are attached and the detected results are sent to a microcomputer. Further, the microcomputer controls the lamp power source and the fan power source based on the temperature changes sent. In addition, the microcomputer controls the lamp power source according to the operation of a remote control transmitting device and is capable of changing the brightness of the screen.

When performing image playback with this liquid crystal display device, the microcomputer changes the amount of light emission by controlling the lamp power source accordingly, for example, when selecting the brightness with a remote control transmitting device.

In this way, the played-back image can be brightened. Meanwhile, the lamp temperature increases with the change in the amount of light emission. The sensor detects this temperature change and sends it to the microcomputer. Further, the microcomputer controls the fan power source based on the sent temperature change and performs cooling by increasing the fan rotation.

In this way, by changing the fan rotation based on the temperature change detected by the sensor, the temperature rise within a projector can be controlled while playing back an image with freely selectable brightness.

### SUMMARY OF THE INVENTION

The present invention is directed to a light source device and a projector having the light source device. The light source device comprises a light emission unit for radiating an illuminating beam; a light emission control unit for controlling an amount of light of the illuminating beam radiated by the light emission unit; a cooling unit for cooling heat generated when the illuminating beam is radiated by the light emission unit; a cooling control unit for controlling an amount of heat for cooling by the cooling unit; an operation unit having the ability to adjust a manipulated variable relative to a prescribed controlled system; and a calculation unit for computing at least one of the controlled variables for the light emission control unit and the cooling control unit, based on the manipulated variable adjusted by the operation unit.

With the light source device in accordance with the invention, first, a user can freely regulate the manipulated variable relative to a prescribed controlled system using the operation unit. When regulating the manipulated variable as shown in FIG. 1, a computation is performed of at least one of the controlled variable of the light emission control unit and the controlled variable of the cooling control unit based on the manipulated variable regulated by the calculation unit.

For example, when computing the controlled variable of the light emission unit, an illuminating beam is radiated by controlling the light emission unit so that the light emission control unit achieves a light amount in accordance with the controlled variable. Meanwhile, when computing the controlled variable of the cooling control unit, the amount of heat from the cooling unit is controlled so that the cooling control unit achieves cooling capacity in accordance with the controlled variable. By doing so, the cooling unit cools the heat generated by the light emission unit at a level of cooling capacity in accordance with the manipulated variable.

The calculation unit may also simultaneously compute the controlled variable of the light emission control unit and the cooling control unit. In this case, an illuminating beam is radiated by the light emission unit while the cooling unit cools the heat.

Preferably, the prescribed controlled system is the cooling unit, the manipulated variable is the amount of light of the illuminating beam, and the calculation unit computes the controlled variable of the cooling control unit according to the amount of light.

Preferably, the prescribed controlled system is the light emission unit, the manipulated variable is the amount of heat for cooling, and the calculation unit computes the controlled variable of the light emission control unit according to the amount of heat for cooling.

Advantageously, the calculation unit includes a convertible LUT that indicates at least one of the controlled variables for the light emission control unit and the cooling control unit in relation to the manipulated variables.

Advantageously, the light source device further comprises an environmental temperature sensor for measuring a temperature inside a case that houses at least the light emission unit and the cooling unit within, and wherein the LUT switches according to the temperature measured by the environmental temperature sensor.

Advantageously, the calculation unit computes at least one of the controlled variables for the light emission control unit and the cooling control unit, by using a computation equation related to the manipulated variable relative to the prescribed controlled system.

Advantageously, the light source device further comprises a display for displaying the manipulated variable, wherein the manipulated variable adjusted by the operation unit is capable of adjustment successively and in multiple stages in two directions displayed on the display, and the calculation unit computes each of the controlled variables so as to lower a light emission amount of the light emission unit and a cooling amount of the cooling unit when the operation unit is adjusted from a high direction towards a low direction of the display.

Preferably, the controlled variable calculated by the calculation unit is a controlled variable to maintain a temperature of the light emission unit to be constant regardless of the manipulated variable adjusted by the operation unit.

Preferably, the controlled variable calculated by the calculation unit is a controlled variable to maintain the temperature of the light emission unit to be constant regardless of an environmental temperature.

Preferably, the light source device further comprises an internal temperature sensor for measuring a temperature of the light emission unit, wherein the controlled variable calculated by the calculation unit is a controlled variable to maintain to be constant a temperature measured by the internal temperature sensor regardless of the controlled variable adjusted by the operation unit.

Preferably, the controlled variable calculated by the calculation unit is a control amount to maintain to be constant a temperature measured by the internal temperature sensor regardless of an environmental temperature.

Preferably, the light emission unit is LEDs, the temperature of the light emission unit is a junction temperature of the LEDs or a temperature of a prescribed part of the light emission unit having a correlation with the junction temperature.

The invention is also related to a light source device. The light source device comprises a light source unit for radiating an illuminating beam by emitting sequentially a plurality of light emitting elements; and a cooling unit for cooling the light source unit by receiving with fluid and radiating heat generated by the emissions of the light emitting elements, wherein a speed of sequential emissions by the light emitting elements is faster or slower than that of the flowing fluid.

The invention is also directed to a projector for projecting an image according to an input video signal. The projector comprises the light source device described above; a spatial modulation unit for modulating the illuminating beam radiated by the light emission unit according to the video signal; and an optical projection unit for projecting the illuminating beam modulated by the special modulation unit.

Preferably, the manipulated variable is a zoom amount of the optical projection unit.

Preferably, the manipulated variable is a focus amount of the projection optical unit.

Preferably, the manipulated variable is an aperture of the projection optical unit.

### BRIEF DESCRIPTION OF THE DRAWINGS

FIG. 1 is a constitutional block diagram for explaining the operation and effects of a light source device in accordance with the present invention.

FIG. 2 is a constitutional diagram for showing a first embodiment of a light source device and a projector in accordance with the present invention.

FIG. 3 is an external view of the projector shown in FIG. 2.

FIG. 4 is a drawing for showing a computation equation used by a calculation means when computing the control amount for the light source device shown in FIG. 2.

FIG. 5 is a drawing for showing another example of the volume shown in FIG. 2.

FIG. 6 is a constitutional diagram for showing a second embodiment of a light source device in accordance with the present invention.

FIG. 7 is a flowchart for radiating an illuminating beam according to the light source device shown in FIG. 6.

FIG. 8 is a drawing for explaining the benefits afforded by switching an LUT according to the light source device shown in FIG. 6.

FIG. 9 is a drawing for explaining an LUT switching method according to the light source device shown in FIG. 6.

FIG. 10 shows a relationship between the number of revolutions of a fan and the light amount determined by the LUT so that a junction temperature of an LED in each environment becomes a value that is several degrees lower than a specification maximum temperature.

FIG. 11 is a constitutional diagram for showing a third embodiment of the light source device in accordance with the present invention.

FIG. 12 is a perspective view for showing an LED light engine of the light source device shown in FIG. 11.

FIG. 13 is a top view of the LED light engine shown in FIG. 12 and shows a relationship between a ring-shaped heat radiating block, a plurality of LEDs, and circulation fluid.

FIG. 14 is an A-A expanded view of the heat radiating block shown in FIG. 13, and shows that a flow path is formed along an outer periphery of the heat radiating block.

FIG. 15 shows a relationship between the lighting direction of the plurality of LEDs and the direction of the circulation fluid flowing through the heat radiating block.

FIG. 16 shows a relationship between the turn-on timing of each LED and the position of the circulation fluid flowing through the heat radiating block.

FIG. 17 shows a relationship between the circulation fluid speed, the pulse movement speed of the LED, and the junction temperature of the LED.

FIG. 18 shows another example of the flow path shown in FIG. 13, which is formed in a zigzag in the orthogonal direction.

FIG. 19 shows another example of the flow path shown in FIG. 13, which is formed in a zigzag in the horizontal direction.

FIG. 20A is a drawing that shows another example of the heat radiating block shown in FIG. 13, and shows a heat radiating block constructed with entrances and exits located at two locations and separated by 180 degrees around a central line of the heat radiating block, in which the circulation fluid flows in the same direction as the lighting direction of the LED.

FIG. 20B shows a heat radiating block constructed after example shown in FIG. 20A, but which is such that that the flow direction of the circulation fluid is partially opposite to the lighting direction of the LEDs.

FIG. 20C shows a heat radiating block constructed with entrances and exits located at three locations and separated by 120 degrees around a central line of the heat radiating block, and the circulation fluid flows in the same direction as the lighting direction of the LEDs.

FIG. 21 is a constitutional diagram for showing a fourth embodiment of the light source device and the projector in accordance with the present invention.

FIG. 22 is a drawing that shows the state in the projector shown in FIG. 21 when the expansion angle is changed in relation to the diaphragm when changing the distance between the DMD and the diaphragm by changing the focus amount.

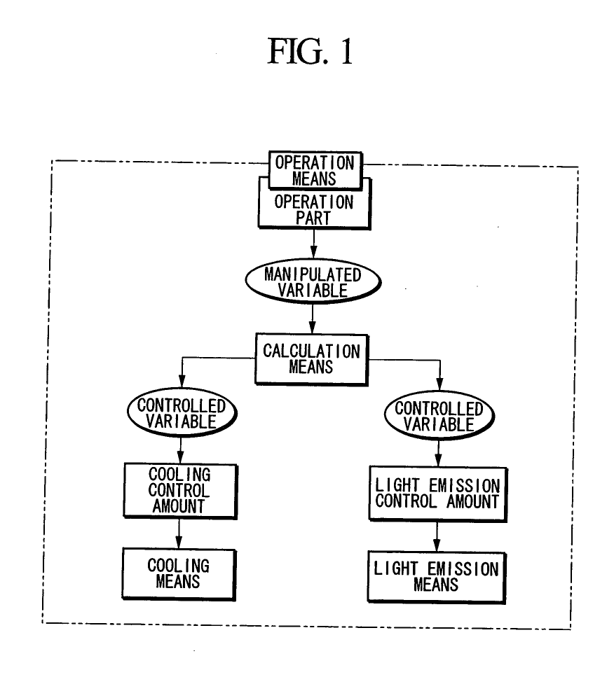

### DETAILED DESCRIPTION OF THE PREFERRED EMBODIMENTS

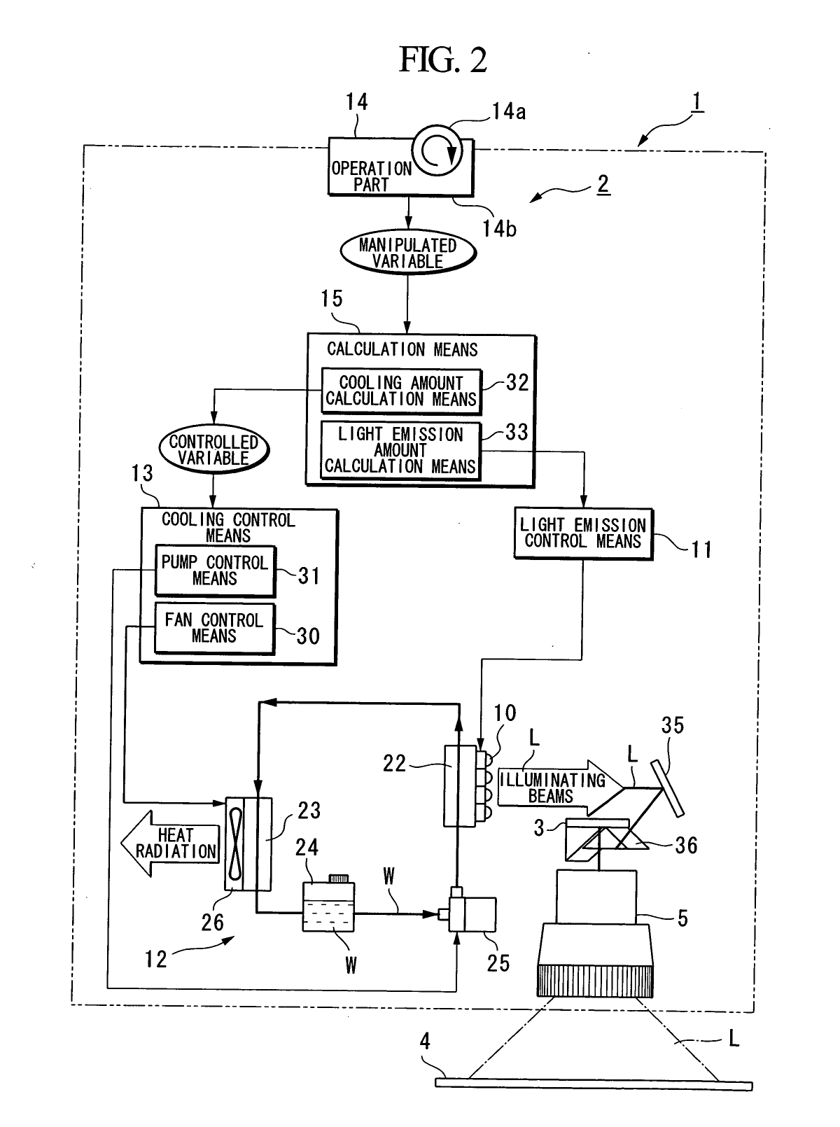

The first embodiment of the light source device and projector in accordance with the present invention is described hereafter with reference to FIG. 2 through FIG. 5.

Projector 1 of the present embodiment projects an image according to an input projection signal, and as shown in FIG. 2, provides a light source device 2, a digital micro-mirror device (hereafter abbreviated as DMD) (spatial modulation means) 3 which modulates the illuminating light L radiated by LEDs (light emission means) 10 to be described hereafter, of the light source device 2 according to a projection signal, and a projection lens (projection optical means) 5 that projects the illuminating light L modulated by the DMD 3 to the screen 4.

The light source device 2 described above provides a plurality of LEDs 10 for irradiating the illuminating light L, a light emission control means 11 for controlling the amount of light of the illuminating beam L radiated by the LEDs 10, a cooling means 12 for cooling the heat generated at the time the plurality of LEDs 10 radiate the illuminating light L, a cooling control means 13 for controlling the amount of heat for cooling by the cooling means 12, in other words, the cooling capacity, an operation means 14 capable of regulating an manipulated variable with respect to a prescribed controlled system, and a calculation means 15 for computing at least one of the manipulated variables of the light emission control means 11 and the cooling control means 13 based on the manipulated variable regulated by the operation means 14.

Moreover, the present embodiment is an example where the prescribed controlled system is the cooling means 12 and the manipulated variable adjusted by the user (operator) is the light amount of the LEDs 10, and the calculation means 15 computes the controlled variable of the cooling control means 13 according to the light amount of the LEDs 10.

Moreover, the projector 1 of the present embodiment, as shown in FIG. 3, has a case 20 formed in a box shape. Further, a volume 14a of the control means 14 and a projection lens 5 are respectively equipped on the top and side of the case 20, and other components are housed therein including at least the plurality of LEDs 10 and the cooling means 12.

The volume 14a is formed in a circular shape when viewed from above and provides incremental resistance at prescribed angles while having the ability to rotate 360° around the rotational axis L1. In this way, the user can operate the volume 14a in multiple stages while feeling a clicking sensation. Furthermore a display label (indicator) 21 is imprinted in the vicinity of the volume 14a on the case 24 indicating the manipulated variable. In other words, the manipulated variable regulated by the volume 14a has the ability to be regulated successively and in multiple stages in the two directions indicated by the size of the display label 21.

In addition, the volume 14a, as shown in FIG. 2, is supported with the ability to rotate with respect to the main operating component 14b equipped within the case 20. In other words, the volume 14a and the main operating component 14b together comprise the operation means 14.

The aforementioned plurality (for instance four) of LEDs 10 is arranged in a line to the heat radiating block 22. These LEDs 10 radiate the illuminating light L by emitting an amount of light according to the power supplied from the light emission control means 11. Further the light emission control means 11 supplies the manipulated variable input by the volume 14a, in other words, power according to the light amount, to the plurality of LEDs 10.

The heat radiating block 22 is formed of materials having favorable heat conductivity, and a flow path not shown in the drawing is formed therein. Further, a channel not shown in the drawing is formed in the flow path, and circulation fluid W capable of delivering heat within the channel and flow path flows therein. The conduit is connected in a closed path state so as to enable continuous circulation of the circulation fluid W.

In addition, a radiator 23, a tank 24, and a pump 25 are connected to the conduit in this order from the heat radiating block 22. In other words, the circulation fluid W circulates in the order of the heat radiating block 22, the radiator 23, the tank 24, and the pump 25.

The pump 25 supplies (sends) the circulation fluid W to the heat radiating block 22 and continuously circulates the circulation fluid W. In addition, space is formed for the circulation fluid W and air to flow respectively, and a large heat transmission surface is secured by using a plate fin that allows effective heat exchange. The radiator 23 has a fan 26 attached in a state of contact which sends a flow of air to the radiator 23. In this way heat exchange is performed between the circulation fluid W and the air enabling significant radiation of heat transferred from the LEDs 10 to the circulation fluid W. Moreover, the fan 26, attached to the case 20, significantly radiates heat from the circulation fluid W to outside the case 20.

The tank 24 is the holding place for the circulation fluid W, and even if the circulation fluid W expands and contracts due to the temperature, the tank 24 acts as a buffer maintaining a state of fixed pressure within the conduit.

The heat radiating block 22, conduit, radiator 23, fan 26, tank 24, and pump 25 comprise the cooling means 12.

In addition, the fan 26 controls the airflow amount flowing to the radiator 23 by controlling the number of revolutions with the fan control means 30. For example, by increasing the number of revolutions of the fan 26, the temperature rise of the LEDs 10 can be further prevented as heat exchange increases with the increase in the amount of airflow flowing to the radiator 23. In other words, the amount of heat that can be cooled by the cooling means 12 can be increased by increasing the number of revolutions of the fan 26, thereby improving cooling capacity.

Meanwhile, in a similar manner the pump 25 controls the amount of circulation fluid W supplied to the heat radiating block 22 by the pump control means 31. For example, by increasing the amount of supply by the pump 25, the temperature rise of the LEDs 10 can be further prevented as heat exchange becomes smoother with the increase in the flow amount of the circulation fluid W sent to the heat radiating block 22. In other words, the amount of heat that can be cooled by the cooling means 12 can be increased by increasing the amount of supply by the pump 25, thereby improving cooling capacity.

The above mentioned fan control means 30 and the pump control means 31 operate the fan 26 and the pump 25 respectively based on the manipulated variable sent from the calculation means 15.

In other words, the fan control means 30 and the pump control means 31 comprise the cooling control means 13 for controlling the cooling capacity of the cooling means 12.

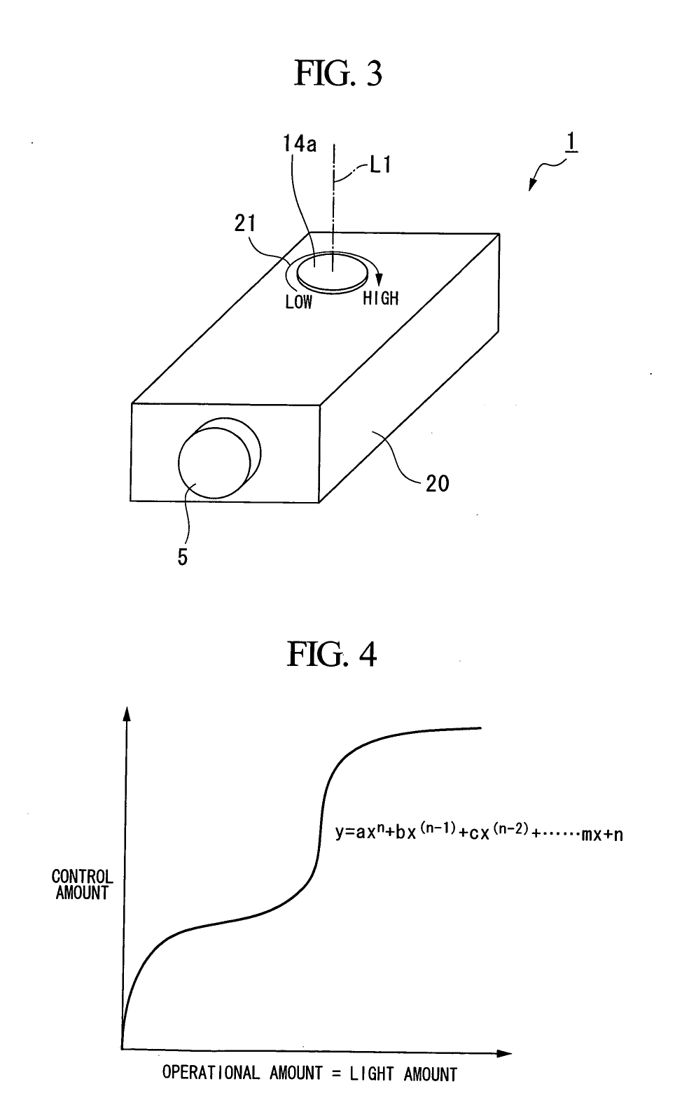

The calculation means 15 contains a cooling amount calculation means 32 and a light emission amount calculation means 33. The cooling amount calculation means 32 computes, using the computation equation shown in FIG. 4, the controlled variable (for instance, a number of revolutions of the fan 26) of the cooling means 12 relative to the light amount (manipulated variable) sent from the operation means 14, then delivers it to the cooling control means 13. The computation equation is an equation determined to bring the LED junction temperature below the specified temperature limit in all user-selectable states and such equation has been confirmed through prior testing.

In addition, the computation equation computes the controlled variable so as to lower the cooling amount of the cooling control means 13 when the volume 14a is adjusted towards the low direction from the high direction of the display label 21. Further, the computation equation can be either an exponential function or a logarithmic function.

Moreover, the light emission amount calculation means 33 computes the controlled variable of the light emission control means 11 according to the computation equation in this manner. However, in the present embodiment, the light amount (manipulated variable) sent from the operation means 14 is sent to the light emission amount calculation means 33. In other words, the prescribed controlled system is the LEDs 10 and the manipulated variable is the cooling heat amount, and the calculation means 15 computes in accordance with the computation equation for the case of computing the controlled variable of the light emission control means 11 according to the cooling heat amount.

Further, the illuminating beam L radiated from the plurality of LEDs 10 is reflected by the reflective mirror 35 and enters the TIR prism 36. The TIR prism 36, which consists of two prisms holding a layer of air between them, has the function of completely reflecting the illuminating beam L which entered from the reflective mirror 35 and causing it to enter into the DMD 3 whereby the illuminating beam L exits from the DMD 3 and enters into the projection lens 5.

The DMD 3 is a semiconductor optical switch having a plurality of micro-drive mirrors not shown in the drawing.

The micro-drive mirrors alter the angle in accordance with ON and OFF states, and light is radiated to the projection lens 5 when the micro-drive mirrors are in the ON state. In addition, modulation can be performed by controlling the ON and OFF states of the micro-drive mirrors according to the input projection signal. In this way, a modulated image can be enlarged by the projection lens 5 and displayed on the screen 4 by controlling the ON and OFF states.

A description is provided hereafter for projecting an image onto the screen 4 using the light source device 2 and the projector 1 constructed in this manner.

First, the user operates the volume 14a to regulate the amount of light of the illuminating beam L radiated by the LEDs 10. The operation means 14 sends the regulated light amount to the calculation means 15. Upon receiving it, the light emission amount calculation means 33 sends the light amount to the light emission control means 11, and the light emission control means 11 determines the power to be supplied to the LEDs 10 in order to emit at the regulated light amount. In this way, the plurality of LEDs 10 radiates the illuminating beam L at the regulated light amount.

The radiated illuminating beam L, after being reflected by the reflective mirror 35 and entering the TIR prism 36, is completely reflected and enters into the DMD 3. After undergoing modulation by the DMD 3 according to the projection signal, the post-modulated illuminating beam L passes through the TIR prism 36 and exits the projection lens 5. Further, the projection lens 5 magnifies the modulated illuminating beam L and displays it on the screen 4. As a result, the projected image can be viewed at the amount of light regulated by the user.

Meanwhile, the cooling amount calculation means 32 computes from the computation equation shown in FIG. 4 the controlled variable of the cooling control means 13 relative to the light amount sent from the operation means 14, and sends the computed controlled variable to the cooling control means 13. The cooling control means 13 controls the cooling means 12 to achieve the cooling capacity based on the controlled variable sent. In other words, the fan control means 30 controls the number of revolutions of the fan 26, and the pump control means 31 controls the supplied amount of circulation fluid W.

The circulation fluid W (flowing in the direction of the arrow) supplied from the pump 25 passes along the flow path of the heat radiating block 22. At such time, the circulation fluid W receives the heat generated by the LEDs 10 through the heat radiating block 22 and thereafter passes through the radiator 23. At that time, the radiator 23 performs a heat exchange with the airflow forcibly generated by the fan 26 thereby significantly radiating the received heat from the circulation fluid W through the fan 26. Thereafter, the circulation fluid W, which radiated the heat, returns to the tank 24 and is once again sent back to the heat radiating block 22 by the pump 25.

In particular, because the circulation fluid W flows at a rate in accordance with the amount of light emitted by the LEDs 10, the heat generated by the LEDs 10 can be reliably received, allowing the temperature rise to be reliably prevented. Furthermore, because the fan 26, in a similar manner, rotates at a rate in accordance with the amount of light emitted by the LEDs 10, heat exchange with the circulation fluid W can be reliably performed allowing heat radiation. As a result, the temperature rise of the LEDs 10 can be prevented in conjunction with preventing the temperature rise within the case 20.

According to the light source device 2 of the present embodiment as described above, heat of the LEDs 10 generated in conjunction with radiating an illuminating beam L at the amount of light regulated by user can be reliably cooled. A temperature rise can be reliably prevented particularly while viewing a projected image as the controlled variable computed by the calculation means 15 to achieve the cooling capacity according to the changed amount of light when a user changes the light amount by operation of the volume 14a.

The calculation means 15 uses a computation equation at the time of computing the controlled variable, and enables an easy construction to be devised with calculations possible to be made by a simple computing circuit and CPU.

In addition, ease of use is made possible because high and low settings can be easily distinguished by the display label 21 when the user operates the volume 14a. Furthermore, operating errors can be significantly reduced due to the ability to easily and reliably adjust the light amount at will as the light amount can be adjusted successively and in multiple stages in two directions for high and low. On account of these things, ease of use and convenience is favorable. Moreover, when adjusting from the high direction to the low direction, operation is easy because computation of the controlled variable is performed to lower the cooling amount of the cooling control means 13 in accordance with the display.

Furthermore, the projector 1 of the present embodiment contains the light source device 2 described above that can adjust the temperature of the LEDs 10 easily and linearly based on the light amount arbitrarily adjusted by the user thereby providing excellent ease-of-use and convenience.

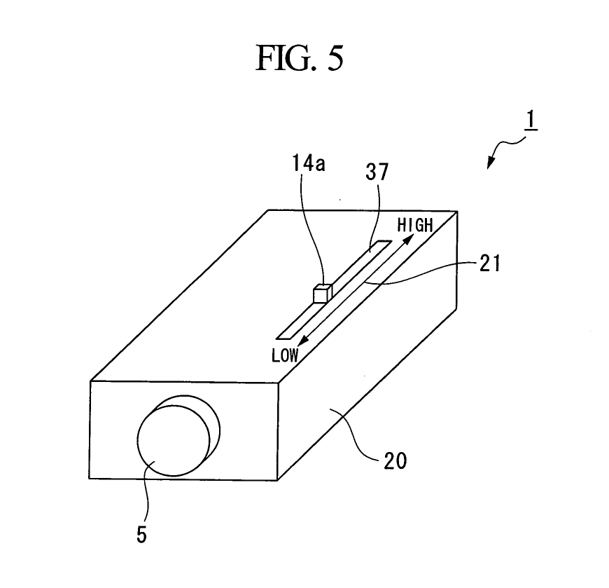

Moreover, in the first embodiment, a circular shaped volume 14a capable of rotational operation is utilized as the operation means 14; however, the volume 14a is not limited to this and may have the ability to move in a direct line along a groove 37 formed along the length of the case 20 as shown in FIG. 5.

Additionally, a composition that provides for the equipping of two buttons for high and low whereby pressing the button for “high” increases the manipulated variable, and pressing the button for “low” decreases the manipulated variable, is also acceptable.

Also, a display label 21 is imprinted on the case 20 as the indicator, but there is no limitation to this, and a liquid crystal display panel or the like may be arranged for liquid crystal display of the manipulated variable may also be acceptable.

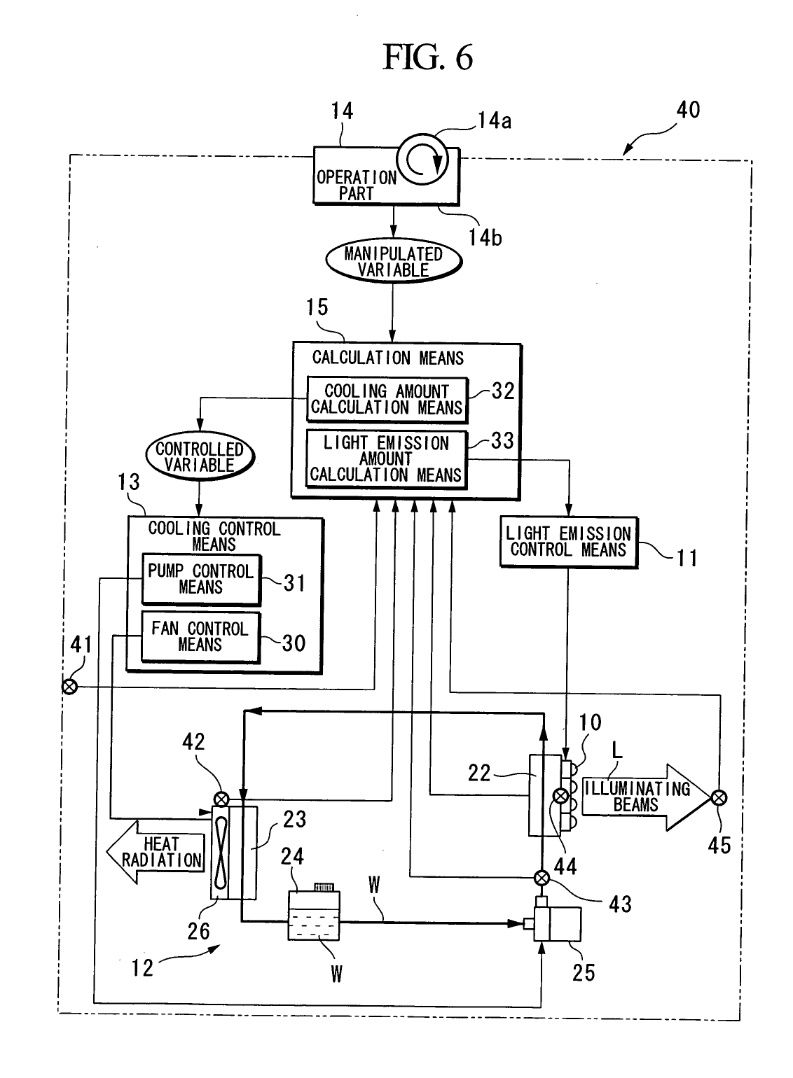

A description of the second embodiment of the light source device in accordance with the present invention is provided hereafter with reference to FIG. 6 through FIG. 10. Moreover, where the same construction exists relative to the first embodiment, the second embodiment utilizes the same reference numbers, while omitting descriptions.

The difference between the second embodiment and the first embodiment lies in the fact that with the first embodiment the calculation means 15 sends the controlled variable of the cooling means 12 to the cooling control means 13 by using the computation equation based on the amount of light sent from the operation means 14, whereas the light source device 40 of the second embodiment computes the controlled variable using a convertible LUT (Look Up Table) for switching according to the environmental temperature T. Moreover, the LUT is a table prepared in advance to determine the output values on a 1 to 1 basis to given input values and it can be realized by a memory.

In other words, the light source device 40 of the present embodiment provides an environmental sensor (temperature sensor) 41 that measures the environmental temperature T within the case 20 as shown in FIG. 6. The environmental temperature T measured by the environmental temperature sensor 41 is sent to the calculation means 15.

Further, the calculation means 15 of the present embodiment contains a convertible LUT for indicating the manipulated variable adjusted by the operation means 14, in other words, the controlled variable of the cooling means 12 (for instance, the number of revolutions of the fan 26) in relation to the light amount. The LUT is switched over according to the environmental temperature T sent from the environmental sensor 14.

More specifically, the calculation means 15 compares the sent environmental temperature T with a setting value Ta set in advance (for example, 23°), and the tilt of the LUT is changed based on the comparison results. A detailed description of this is provided hereafter.

In addition, the light source device 40 of the present embodiment provides a variety of sensors in addition to the environmental temperature sensor 41. In other words, a rotation sensor 42 that measures the number of revolutions of the fan 26, a flow amount sensor 43 that measures the flow amount of the circulation fluid W sent from the pump 25, and the internal temperature sensor 44 that directly measures the temperature of the plurality of LEDs 10, and a light amount sensor 45 that measures the light amount of the illuminating beam L radiated from the LEDs 10, are provided. The measurement results measured by each of these sensors are sent to the calculation means 15.

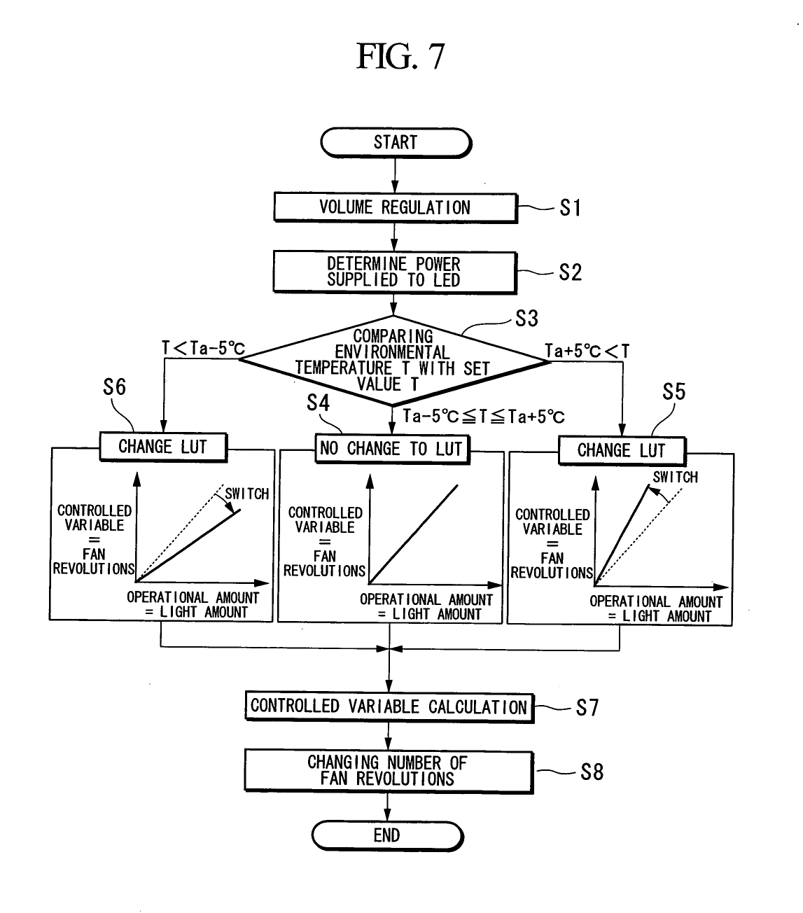

A description is provided with reference to FIG. 7 of radiating the illuminating beam L using the light source device 40 constructed in this manner. Moreover, the present embodiment is a description of changing the cooling effectiveness by controlling the number of revolutions of the fan 26.

First, a user operates the volume 14a to adjust the light amount of the LEDs 10 (S1).

The light emission amount calculation means 33 within the calculation means 15 sends the light amount to the light emission control means 11. Further, the light emission control means 11 measures the power supplied to the LEDs 10 according to the light amount (S2). In this way, a plurality of LEDs 10 radiates an illuminating beam L at the regulated light amount.

In addition, the cooling amount calculation means 32 within the calculation means 15 compares the environmental temperature T sent from the environmental temperature sensor 41 with the set value Ta, and then switches over the LUT (S3). If the result of the comparison is that the environmental temperature T is within ±5° C. of the set value Ta (Ta−5° C.≦T≦Ta+5° C.), then no change to the LUT is performed. (S4). Further, if the environmental temperature T is higher than the set temperature Ta+5° C. (T>Ta+5° C.), then the tilt of the LUT is raised (S5). In this manner, the number of revolutions of the fan 26 can be increased in relation to the same light amount by comparing with the case of no changes to the LUT. In addition, if the environmental temperature T is lower than the set value Ta−5° C. (T<Ta−5° C.), then the tilt of the LUT is reduced (S6). In this manner, the number of revolutions of the fan 26 can be reduced relative to the same amount of light in comparison with the case of no changes to the LUT.

After performing the switching over of the LUT, the cooling amount calculation means 32 computes the controlled variable at the LUT after switching (S7). Further, the fan control means 30 changes the number of revolutions of the fan 26 based on the computed controlled variable (S8). In this way, the LEDs 10 are cooled by changing the cooling capacity.

According to the light source device 40 of the present embodiment in this manner, the time required by the calculation means 15 to compute the controlled variable can be significantly shortened enabling the temperature control to be performed in a very short time because the computation of the controlled variable is performed using the LUT and not a computation equation.

In addition, this relates not simply to the use of an LUT but enables the use of an LUT that is suited to the environmental temperature Ta. Normally, the cooling capacity is the change in the environmental temperature T, but there is the possibility of cooling to a greater extent than is necessary if the environmental temperature T is low. However, as described above, because the LUT switches in accordance with the environmental temperature T, an optimal LUT can always be used for the environmental temperature T. As a result, the cooling capacity can be optimized for the most effective cooling while reliably cooling the LEDs 10 thereby enabling energy conservation and noise reduction.

A description of the benefits of switching over the LUT is given in greater detail hereafter, with reference to FIG. 8.

First, the heat generated from the LEDs 10 is significantly radiated by the radiator 23 and the fan 26. In other words, a heat exchange is performed between the circulation fluid W and the air. Therefore, if the number of revolutions of the fan 26 (thick dotted line, indicating the replacement to the power consumption) is the same, then the cooling capacity increases to the extent that the environmental temperature is low, and the junction temperature of the LEDs 10 is lowered (thin dotted line).

Here, cooling capacity can be lowered by switching over the LUT because the same temperature is used for the junction temperature of the LEDs 10 when the environmental temperature T is high, that is to say, making a fixed temperature (thin solid line). In other words, the power consumption can be reduced (thick solid line) by lowering the number of revolutions of the fan 26 in conjunction with the environmental temperature T thereby enabling energy conservation and noise reduction.

Moreover, the light source device 40 of the present embodiment has the ability to more reliably radiate an illuminating beam L at the regulated light source as well as more reliably prevent temperature rise of the LEDs 10 because each constructional member can be operated more accurately because various sensors, namely, the revolution sensor 42, flow amount sensor 43, internal temperature sensor 44, and light amount sensor 45 are provided.

Moreover, the present embodiment compares the environmental temperature T with the set value Ta plus 5° C. or the set value Ta minus 5° C., but it is not limited to this and can be set freely.

In addition, when switching over the LUT, judgment for switching over is based on the environmental temperature, but this is not a limitation. For example, judgment of the heat amount generated by the LEDs 10 and the switching over of the LUT can also be performed in accordance with the difference between the temperature measured by the environmental temperature sensor 41 and the temperature measured by the internal temperature sensor 44. Further, judgment of the heat amount generated by the LEDs 10 and the switching over of the LUT can also be performed in accordance with the temperature difference between the entrance and exit of the flow path of the heat radiating block 22 and the flow amount of the circulation fluid W measured by the flow amount sensor 43.

A detailed description will be given herein of the switching over of the calculation method (LUT).

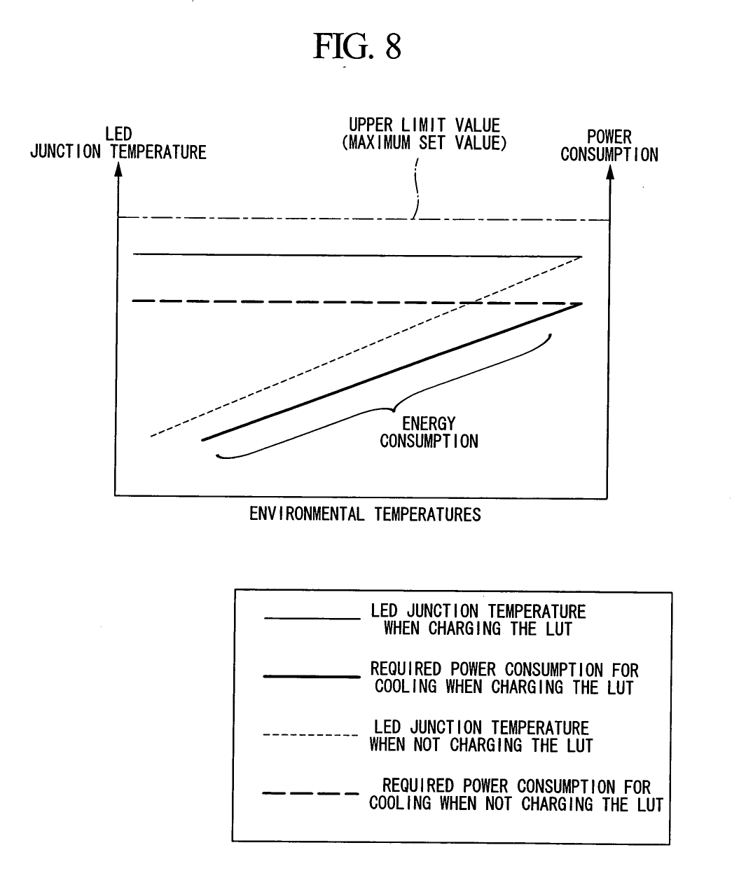

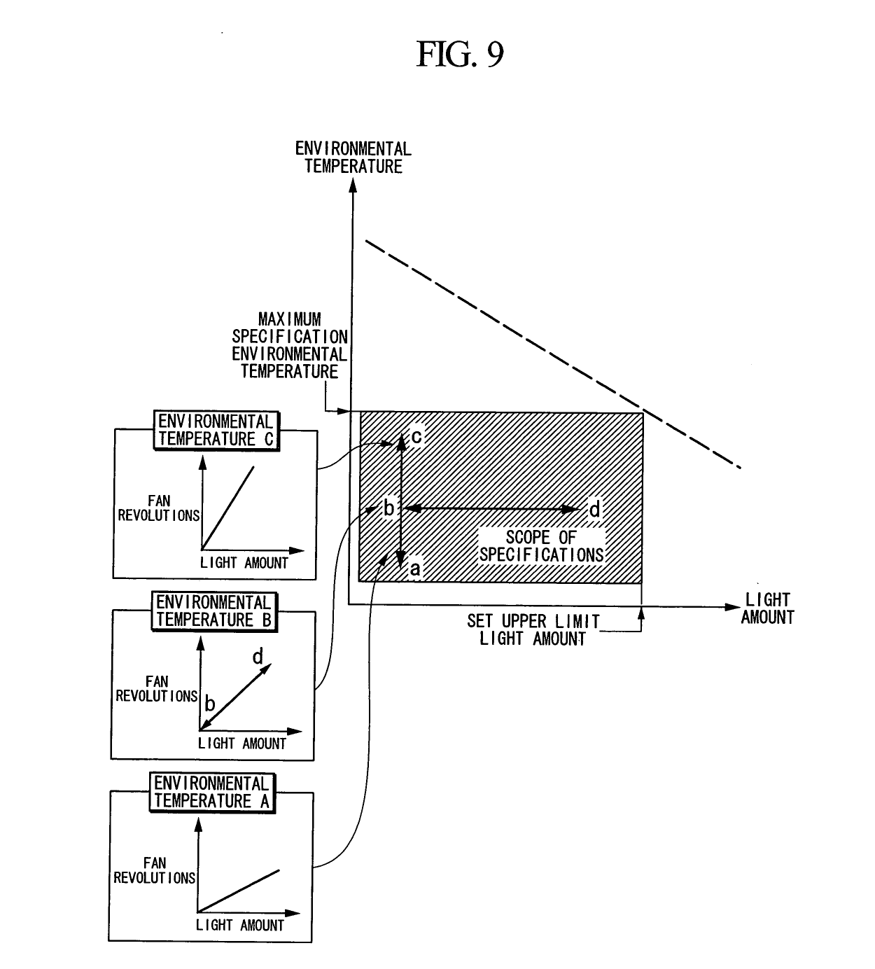

Normally, the specification range of the product, as shown in FIG. 9, is within the boundaries of the maximum light amount and the maximum specification environmental temperature. Here, when the environmental temperature changes in a parallel direction to the vertical axis (environmental temperature) as shown from a to c or from c to a, the LUT switches over. For example, when the environmental temperature changes from a to c, the LUT changes from the LUT of “environmental temperature A” to the LUT of “environmental temperature C” and the control of the number of revolutions of the fan 26 is determined from such LUT and the light amount which is the manipulated variable. Moreover, the number of LUT may be indefinite.

Further, when changing the light amount in a horizontal direction (light amount) as shown from d to b or from b to d, the LUT is not changed. For example, in the case of “environmental temperature B”, when the light amount is changed from b to d, the LUT determines the controlled variable of the number of revolutions of the fan 26 from the light amount which is the manipulated variable in accordance with “environmental temperature B.”

Further, the second embodiment may also be constructed so that the controlled variable computed by calculation means 15 becomes the controlled variable that can maintain a fixed temperature of the LED 10 regardless of the temperature measured by the environmental temperature sensor 41 and the manipulated variable measured by the operation means 14.

For example, when the light amount is changed due to operation by the user, the number of revolutions by the fan 26 is determined by the LUT. At such time, the LUT, as shown in FIG. 8, is a relational equation which makes a determination according to a relational equation between the number of revolutions of the fan 26 and the light amount measured so as to establish a fixed junction temperature of the LEDs 10 at a value that is several degrees lower than the specification maximum temperature. For example, the relational equation determines that when the upper limit of the junction temperature of the LEDs 10 is 90° C., the junction temperature of the LEDs in the environmental temperature is respectively 80±3° C.

Moreover, since the junction temperature of the LEDs is difficult to measure directly, it has been confirmed by simulation and prior temperature testing.

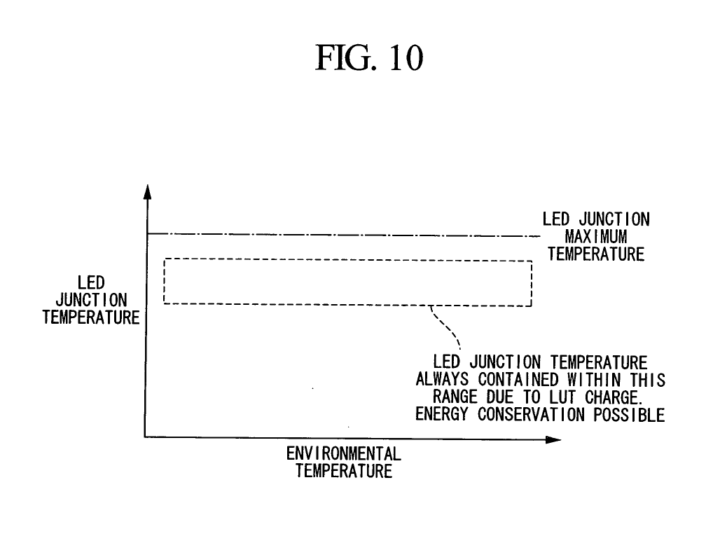

In addition, when reducing the light amount, as shown in FIG. 10, the number of revolutions of the fan 26 is reduced in accordance with the manipulated variable output by the LUT that determines a fixed junction temperature of the LEDs 10. As a result, the power consumption by the fan 26 is reduced enabling energy conservation and noise reduction. Moreover, energy conservation and noise reduction are achieved to the extent that the junction temperature of the LEDs 10 approaches the specification maximum temperature.

In addition, the second embodiment can also be constructed so that the controlled variable computed by the calculation means 15 becomes the controlled variable that can maintain a fixed temperature measured by the internal temperature sensor 44 regardless of the temperature measured by the environmental temperature 41 and the controlled variable regulated by the operation means 14.

The internal temperature sensor 44 indirectly measures the junction temperature of the LEDs 10, and forecasts the junction temperature of the LEDs from the temperature of the measurement component by pre-confirming the heat resistance from the measurement part to the LEDs 10 junction.

A description of the third embodiment of the light source device in accordance with the present invention is provided hereafter, with reference to FIG. 11 to FIG. 17. Moreover, for constructions in the third embodiment that is the same as in the first embodiment, the same reference numbers will be used, while descriptions thereof will be omitted.

The difference between the first embodiment and the third embodiment is that although an illuminating beam L is radiated from a plurality of LEDs 10 arranged in a line to the heat radiating block 22 with the first embodiment, the light source device 50 of the third embodiment, as shown in FIG. 11, radiates an illuminating light L using an LED light engine (light source means) 52 attached to a heat radiating block 51 formed in a ring shape.

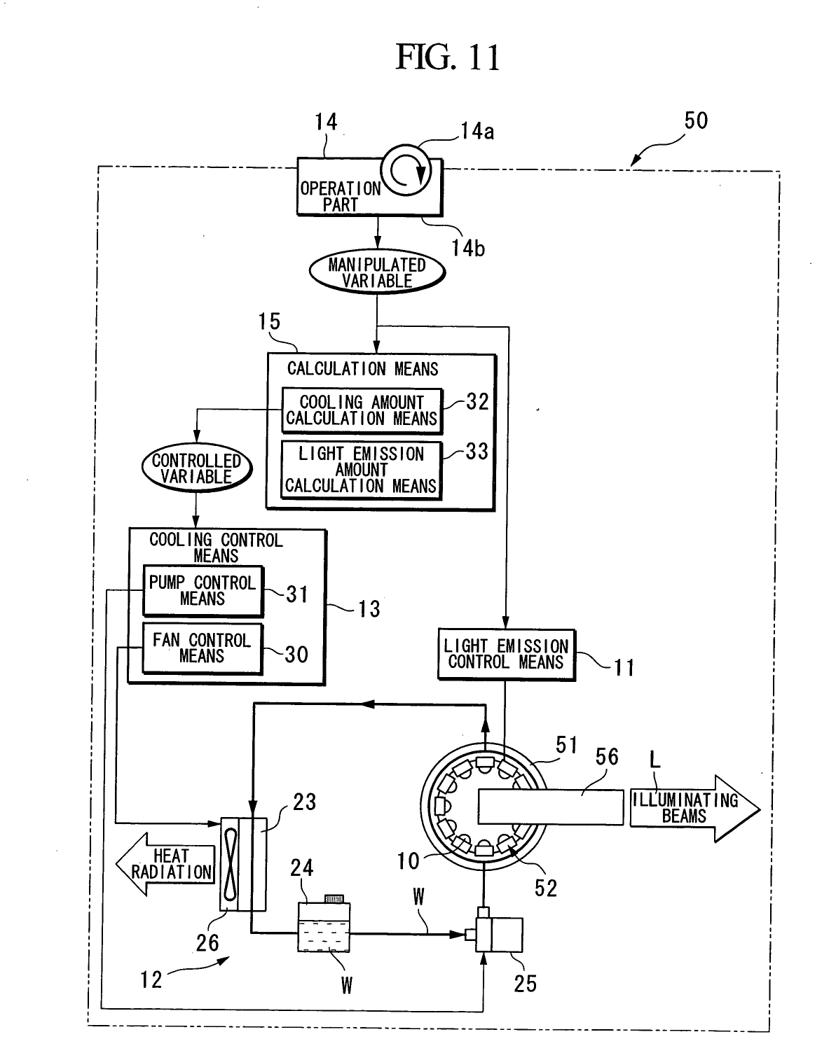

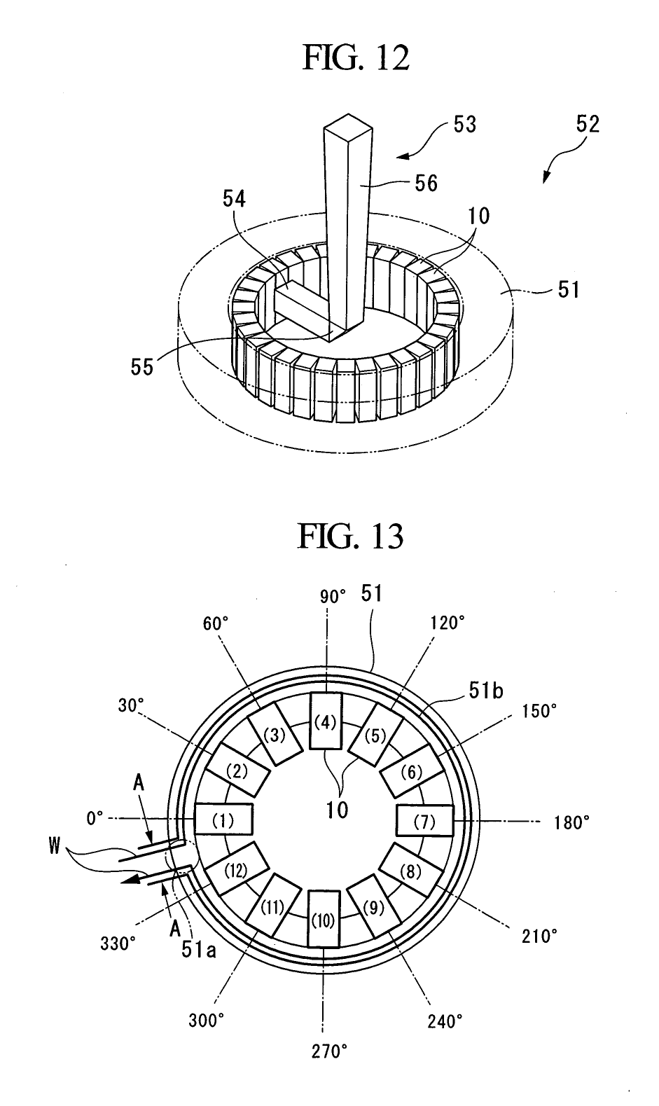

The LED light engine 52, as shown in FIG. 12, is arranged in a ring shape along the peripheral surface of the heat radiating block 51, and provides a plurality (for instance, 12 units) of LEDs (light emitting element) 10 with controlled lighting timing so as to light sequentially using the light emission control means 11, and a light guiding means 52 that directs the illuminating beams L produced sequentially by the plurality of LEDs 10 to a reflective mirror 35.

The light guiding means 53 is made to rotate using a motor, not shown in the drawing, with the center line of the heat radiating block 51, that is, the center line of the plurality of LEDs 10 placed in a ring, made to be the center of rotation, and provides a parallel rod 54 arranged with the incidence tip facing towards to the LEDs 10, a prism 55 for changing the direction by 90 degrees of the illuminating beam L incident from the incidence tip of the parallel rod 54, and a light guiding rod 56 for directing the illuminating beam L incident from the prism 55 into a reflective mirror 35.

Moreover, the motor controls the number of revolutions so that the parallel rod 54 rotates in conjunction with the lighting timing of the plurality of LEDs 10.

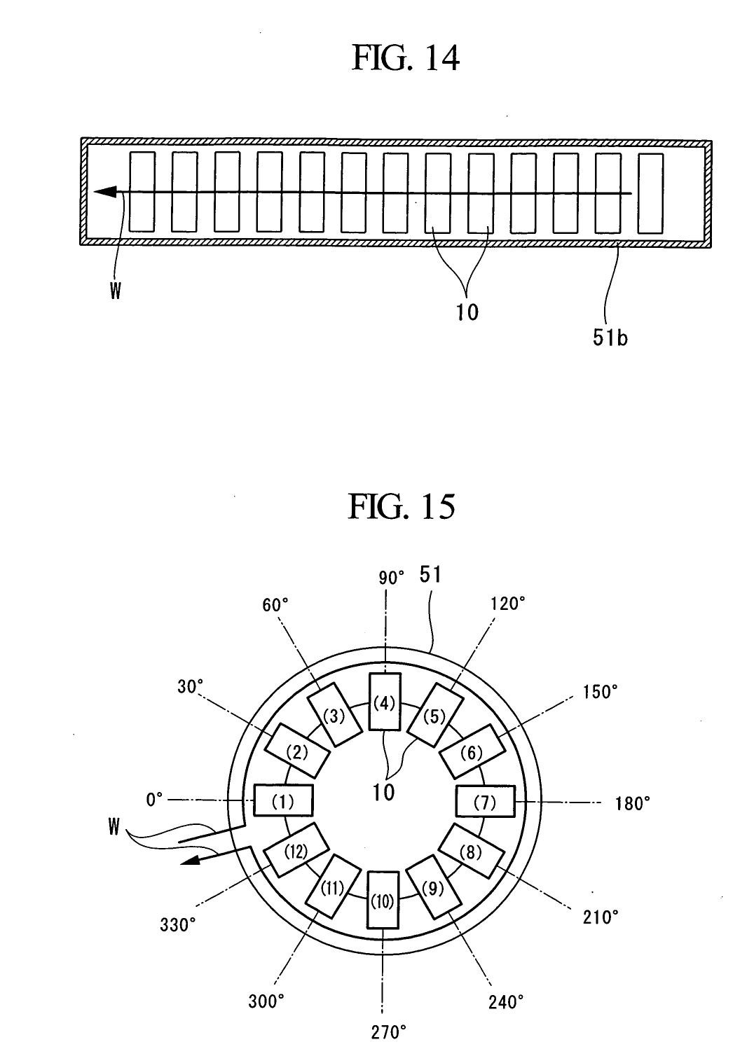

The heat radiating block 51 attaches to the radiation surface which is on the outside of the LEDs 10. Further, an entrance and exit 51a for the circulation fluid to come and go and a flow path 51b within the heat radiating block 51 where the circulation fluid W flows in a single direction, are formed as shown in FIG. 13 and FIG. 14.

Moreover, the entrance and exit 51a is arranged at one location so that the circulation fluid W flows towards the radiator 23 after flowing for one cycle in the heat radiating block 51.

Furthermore, the pump control means 31 controls the speed of the circulation fluid W being sent from the pump 25 so as not to be the same speed as the radiation speed of the illuminating light L sequentially produced by the LEDs 10.

In other words, it is controlled so that the speed of the circulation fluid W is either faster or slower than the pulse movement rate of the LEDs 10.

A description is given hereafter of irradiating an illuminating light L using the light source device 50 constructed in this manner.

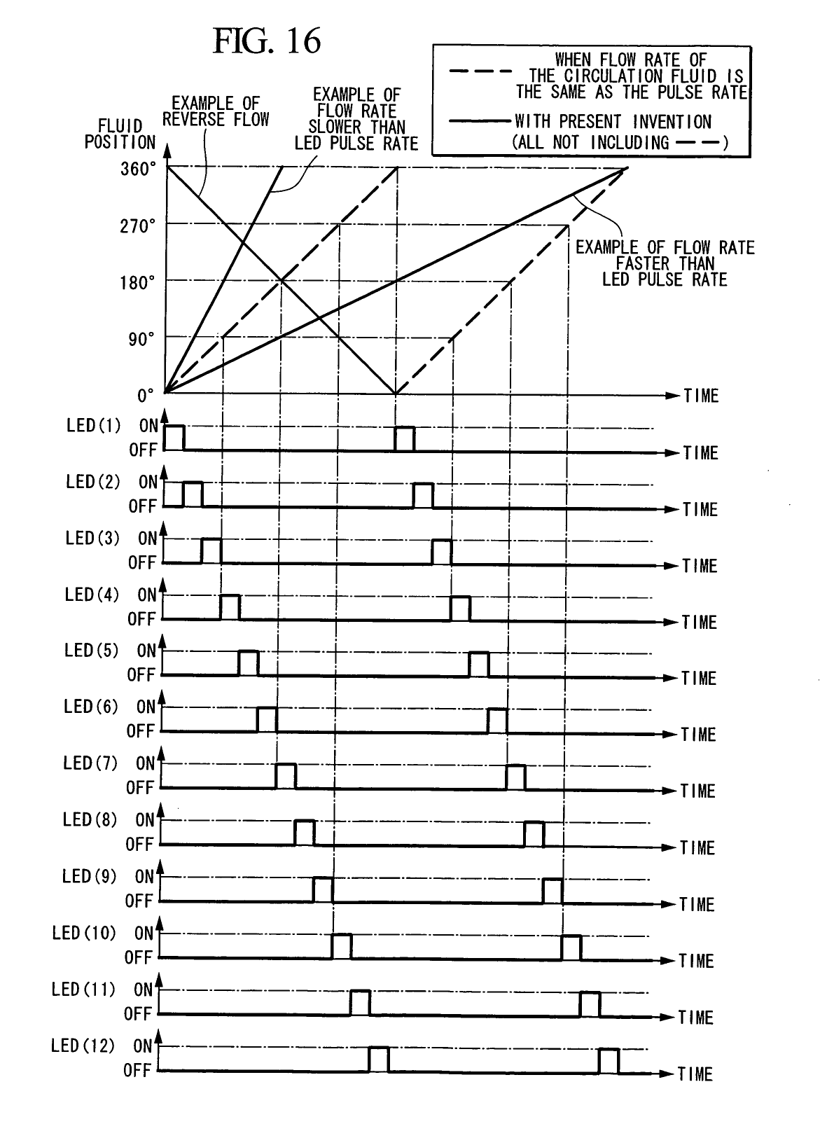

First, the light emission control means 11 determines the power supplied amount to the LEDs 10 based on the manipulated variable, namely the light amount, regulated by the operation means 14, and radiates illuminating beams L by sequentially lighting the plurality of LEDs 10 as shown in FIG. 15 and FIG. 16.

At the same time, the motor rotates the light guiding means 53 for incidence of the sequentially radiated illuminating beams L into the parallel rod 54. The incident illuminating beams L enter the light guiding rod 56 through the prism 55 and enter the reflective mirror 35 due to the light guiding rod 56. Thereafter, they are projected onto the screen 4 by the projection lens 5.

Meanwhile, the cooling amount calculation means 32 determines the cooling capacity by computing the controlled variable of the cooling control means 13 based on the light amount regulated by the operation means 14. The pump control means 31 determines the supply amount of circulation fluid W sent from the pump 25 based on this controlled variable. Furthermore, the circulation fluid W sent from the pump 25 enters into the flow path 51b within the heat radiating block 51 from the entrance and exit 51a as shown in FIG. 13 and FIG. 14, and flows in the same direction as the lighting direction of the plurality of LEDs 10, flowing one cycle around the heat radiating block 51, where it exits the heat radiating block 51 from the entrance and exit 51a towards the radiator 23.

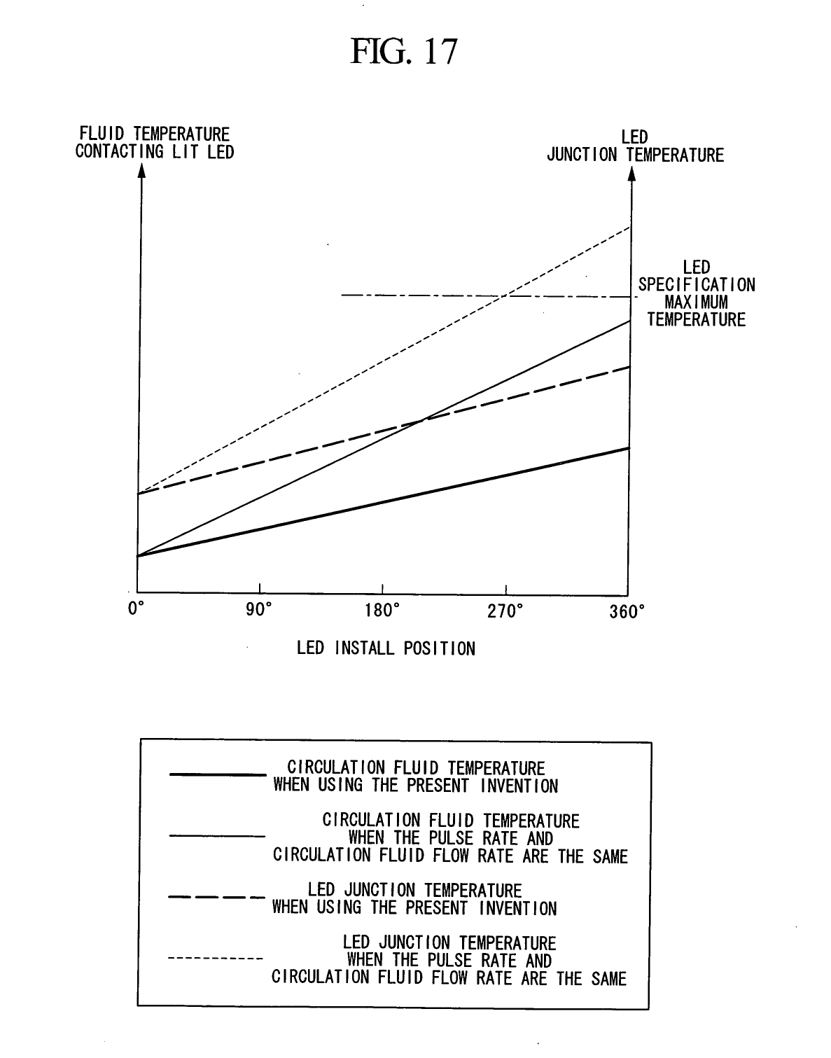

Here, when the flow rate of the circulation fluid W and the pulse movement speed, namely, the lighting speed of the LED 10, are the same as shown in FIG. 16, certain portions of the fluid always receive heat from the LEDs 10 leading to a rise in temperature at that spot in the fluid. As a result, the temperature of the circulation fluid W raises in the downstream flow of the flow path 51b thereby reducing cooling capacity. Therefore, as shown in FIG. 17, sufficiently receiving the heat of the LEDs 10 becomes difficult causing the junction temperature of the LEDs 10 to exceed the specification maximum temperature which increases the likelihood of damage to the LEDs 10.

In contrast, the light source device 50 of the present embodiment controls the flow rate of the circulation fluid W to be faster or slower than the pulse movement speed of the LED 10 as described above, and therefore can cool the LEDs 10 with sufficient cooling capacity as well as prevent damage to the LEDs 10 because the temperature of the circulation fluid W, as described in FIG. 17, does not significantly rise in comparison to the case above (a slight rise may occur due to heat transfer from the circulation fluid W itself).

Moreover, when the circulation fluid W flows in the direction opposite to the lighting direction of the LEDs 10, the flow rate of the circulation fluid W can be the same as the pulse movement speed of the LEDs 10.

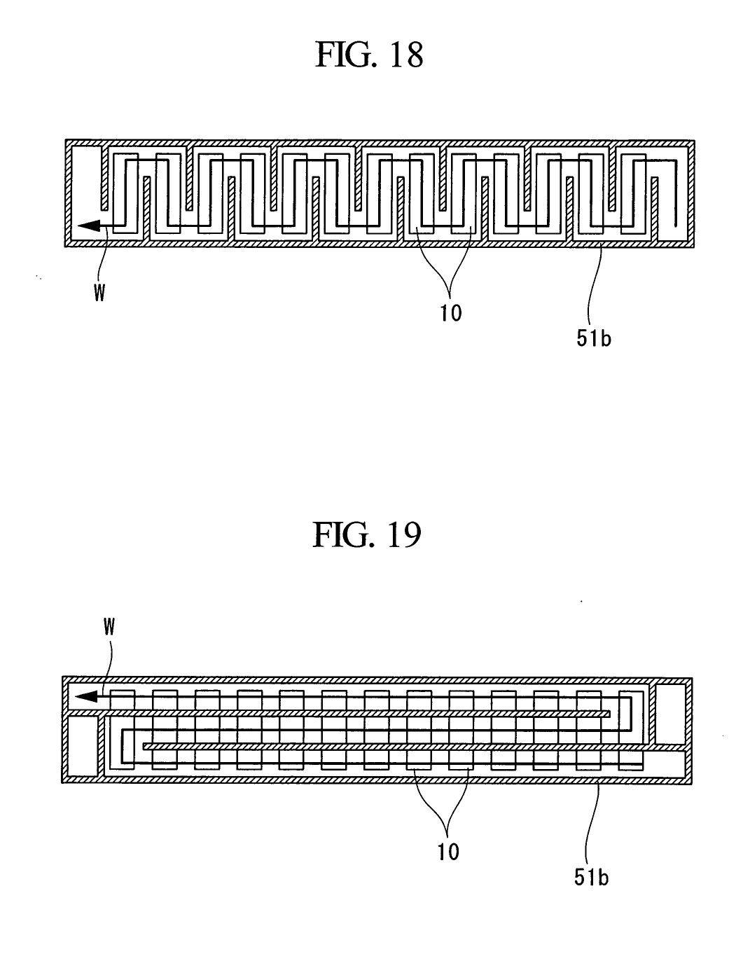

Furthermore, the embodiment described above has the circulation fluid W simply flow in one cycle around the heat radiating block 51. However, as shown in FIG. 18, the flow path 51b of the heat radiating block 51 may also be a zigzag path in the orthogonal direction, or as shown in FIG. 19, a zigzag flow path b in the parallel direction is also acceptable.

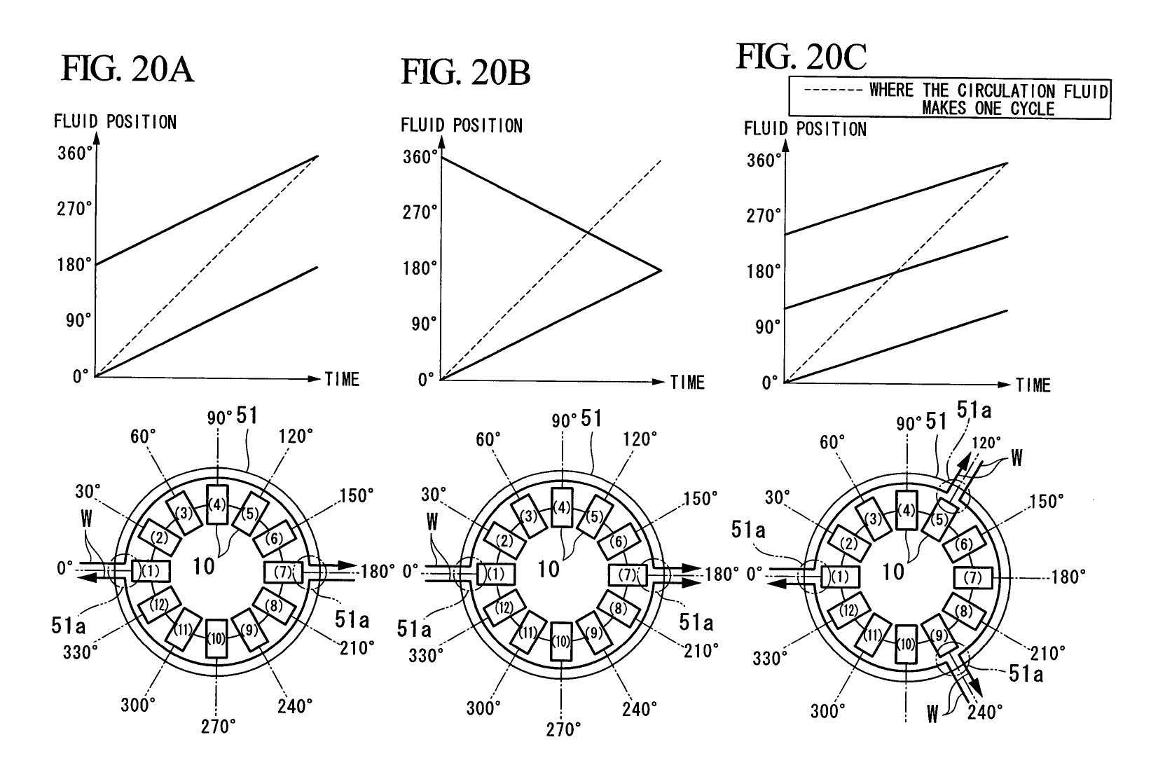

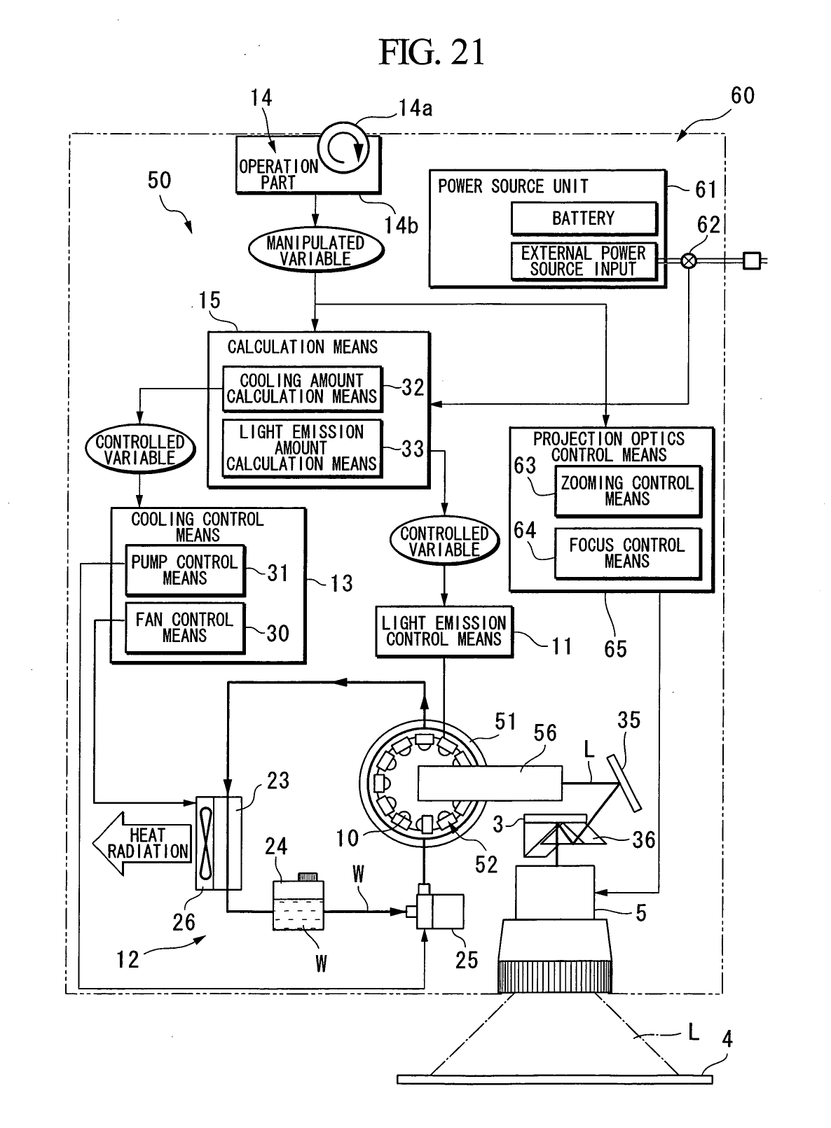

In addition, the embodiment described above arranges the entrance and exit 51a of the circulation fluid W in one location with a construction such that the circulation fluid W travels one cycle around within the heat radiating block 51, but it is not so limited. For example, as shown in FIG. 20A, a construction is also acceptable where the entrances and exits 51a are arranged in two locations separated at 180 degrees around a central line of the heat radiating block 51, and the circulation fluid W can flow in the same direction as the lighting direction of the LEDs 10. Additionally in this case, as shown in FIG. 20B, a construction is also acceptable where the circulation fluid W flows from one entrance and exit 51a to another entrance and exit 51a, and the flow direction of the circulation fluid W is partially in the direction opposite to the lighting direction of the LEDs 10.

Furthermore, the entrances and exits 51a are not limited to two locations, but as shown in FIG. 20C, a construction is also acceptable where three locations are arranged separated at 120 degrees around a central line of the heat radiating block 51, and the circulation fluid W flows in the same direction as the lighting direction of the LEDs 10. Moreover, in this case as well, a construction is allowed where the flow direction of the circulation fluid W is partially opposite to the lighting direction of the LEDs 10.

Moreover, the entrances and exits 51a are not limited to two locations or three locations, but may be arranged in a greater number of locations.

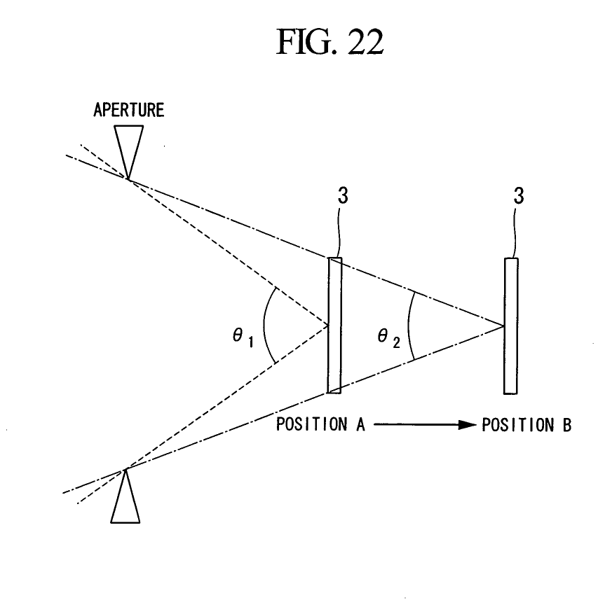

Next, a description is given with reference to FIG. 21 and FIG. 22 of the fourth embodiment of the light source device and projector in accordance with the present invention. Furthermore, for constructions in the fourth embodiment that are the same as in the first embodiment, the same reference numbers will be used and descriptions thereof will be omitted.

The difference between the first embodiment and the fourth embodiment lies in the fact that although the illuminating beam L is radiated from the LEDs 10 arranged in a line to the heat radiating block 51 and the light amount is regulated by the operation means 14 in the projector 1 of the first embodiment, the projector 60 of the fourth embodiment, as shown in FIG. 21, provides the light source device 50 of the third embodiment in addition to an manipulated variable adjusted by the operation means 14 which includes at least one of a zoom amount, focus amount, and aperture.

In addition, the projector 60 of the present embodiment provides a power observation sensor 62 that observes the power of the power unit (a battery or external power input) which supplies electrical power to each of the components, and a projection optics control means 65 containing the zoom control means 63 for controlling the zoom amount of the projection lens 5 as well as a focus control means 64 for controlling the focus amount.

A description is provided for projecting an illuminating beam L using the projector 60 constructed in this manner.

The light amount must be changed by the projection optics control means 65 in order to maintain the manipulated variable set by the user because the optical efficiency changes when changing the zoom amount, focus amount, or aperture amount.

For example, when changing the focus amount, the angle subtending the diaphragm changes, as shown in FIG. 22, because the distance between the DMD 3 and the diaphragm placed at the projection lens 5 changes, thereby changing the amount of light that passes through the diaphragm. In other words, the brightness is changed. More specifically, as shown in FIG. 22, when the position of the DMD 3 changes from “position A” to “position B”, the angle subtending the diaphragm changes from θ1 to θ2. Therefore, since θ1 is greater than θ2, the light amount that passes through the diaphragm is reduced, which reduces the brightness of the illuminating beam L.

In this way, the light amount must be changed in accordance with the focus amount since it is different from the light amount set by the user. Further, the controlled variable of the cooling means 12 according to the light amount set in accordance with the zoom amount, focus amount, and diaphragm amount is computed in the same manner as with each embodiment described above, for example, by the LUT of the light amount and number of revolutions of the fan 26.

Further, the relationship between the light amount and the zoom amount, focus amount, and diaphragm amount may be determined by the LUT or by arranging a light sensor to measure the light amount of the illuminating beam L to feedback a signal measured by the light sensor to the calculation means 15.

Further, the technical scope of the present invention is not limited to the embodiments described above, but various modifications are possible within the range that does not deviate from the essence of the present invention.

For example, with each of the embodiments, an example is described in which the prescribed controlled system is the cooling means, the manipulated variable adjusted by the user is the light amount of the LEDs, and the calculation means computes the controlled variable of the cooling control means according to the light amount of the LEDs. However, it is not limited to this and, for example, a composition is acceptable in which the prescribed controlled system is the LEDs, the manipulated variable adjusted by the user is the cooling amount, and the calculation means computes the controlled variable of the light generation means according to the amount of cooleing.

In such a case, when the user adjusts the volume, the manipulated variable is sent to the control means and the amount of cooling is adjusted by the cooling means. Meanwhile, the manipulated variable is sent also to the light emission amount calculation means and the controlled variable for the LEDs is computed while the LEDs are lit in accordance with the controlled variable computed by the light emission control means.

In addition, with each of the embodiments, the cooling control means may also be an airflow control for the number of revolutions of the fan, or a flow amount control for the circulation fluid.

An airflow control is a means for changing the power consumption by changing the air flow, and it may be a method for changing the revolution of the motor on the pump, or for changing the voltage supplied to the pump motor.

Further, the flow amount control is a means for changing the power consumption by changing the flow amount, and it may be a method for changing the revolution of the motor on the pump, or for changing the voltage supplied to the pump motor, or for changing the diaphragm opening of the conduit flow path.

In addition, with each of the embodiments described above, the cooling means is not limited to only cool water or coolant, but also includes anything utilizing a cool wind or a refrigeration circuit using only a fan. Further, the pump is a means for moving a fluid and may be either electric or pneumatic. Moreover, the fan is a means for creating and sending an air flow, and an axial flow fan, a silocco fan or blower is also acceptable.

Further, the radiator is a means to enable heat exchange, and a heat sink or plate type heat exchanger, or fin-tube heat exchanger is also acceptable. Depending on the amount of heat, natural radiation without using a fan may be acceptable. Furthermore, a heat exchanger, which is not a radiator, for enabling heat exchange between a fluid and a fluid is also acceptable. Moreover, the fluid at the radiation side in this case must be especially simple such as city water.

In addition, the circulation fluid is a medium for transferring heat and can be anything as long at it does not cause corrosion to machinery such as pumps.

According to a light source device in accordance with the invention, a user can adjust a manipulated variable by operating operation means voluntarily depending on a situation, and then adjust temperature by changing at least one of the light amount of light emission means and the cooling ability of cooling means. Accordingly, contrary to the conventional technology, the light source device can provide easy and linear temperature adjustment based on the manipulated variable with respect to a predetermined controlled system.

In addition, according to a projector in accordance with the invention, the projector is easy to use and excellent in convenience, since it includes the light source device that provides easy and linear temperature adjustment based on the manipulated variable with respect to a predetermined controlled system.

1. A light source device comprising:
a light emission unit for radiating an illuminating beam;
a light emission control unit for controlling an amount of light of the illuminating beam radiated by the light emission unit;
a cooling unit for cooling heat generated when the illuminating beam is radiated by the light emission unit;
a cooling control unit for controlling an amount of heat for cooling by the cooling unit;
an operation unit having the ability to adjust a manipulated variable relative to a prescribed controlled system; and
a calculation unit for computing at least one of the controlled variables for the light emission control unit and the cooling control unit, based on the manipulated variable adjusted by the operation unit.

2. The light source device according to claim 1, wherein the prescribed controlled system is the cooling unit, the manipulated variable is the amount of light of the illuminating beam, and the calculation unit computes the controlled variable of the cooling control unit according to the amount of light.

3. The light source device according to claim 1, wherein the prescribed controlled system is the light emission unit, the manipulated variable is the amount of heat for cooling, and the calculation unit computes the controlled variable of the light emission control unit according to the amount of heat for cooling.

4. The light source device according to claim 1, wherein the calculation unit includes a convertible LUT that indicates at least one of the controlled variables for the light emission control unit and the cooling control unit in relation to the manipulated variables.

5. The light source device according to claim 4, further comprising an environmental temperature sensor for measuring a temperature inside a case that houses at least the light emission unit and the cooling unit within, and wherein the LUT switches according to the temperature measured by the environmental temperature sensor.

6. The light source device according to claim 1, wherein the calculation unit computes at least one of the controlled variables for the light emission control unit and the cooling control unit, by using a computation equation related to the manipulated variable relative to the prescribed controlled system.

7. The light source device according to claim 1, further comprising a display for displaying the manipulated variable, wherein the manipulated variable adjusted by the operation unit is capable of adjustment successively and in multiple stages in two directions displayed on the display, and the calculation unit computes each of the controlled variables so as to lower a light emission amount of the light emission unit and a cooling amount of the cooling unit when the operation unit is adjusted from a high direction towards a low direction of the display.

8. The light source device according to claim 1, wherein the controlled variable calculated by the calculation unit is a controlled variable to maintain a temperature of the light emission unit to be constant regardless of the manipulated variable adjusted by the operation unit.

9. The light source device according to claim 8, wherein the controlled variable calculated by the calculation unit is a controlled variable to maintain the temperature of the light emission unit to be constant regardless of an environmental temperature.

10. The light source device according to claim 1, further comprising an internal temperature sensor for measuring a temperature of the light emission unit, wherein the controlled variable calculated by the calculation unit is a controlled variable to maintain to be constant a temperature measured by the internal temperature sensor regardless of the controlled variable adjusted by the operation unit.

11. The light source device according to claim 10, wherein the controlled variable calculated by the calculation unit is a control amount to maintain to be constant a temperature measured by the internal temperature sensor regardless of an environmental temperature.

12. The light source device according to claim 8, wherein the light emission unit is LEDs, the temperature of the light emission unit is a junction temperature of the LEDs or a temperature of a prescribed part of the light emission unit having a correlation with the junction temperature.

13. A light source device comprising:
a light source unit for radiating an illuminating beam by emitting sequentially a plurality of light emitting elements; and
a cooling unit for cooling the light source unit by receiving with fluid and radiating heat generated by the emissions of the light emitting elements,
wherein a speed of sequential emissions by the light emitting elements is faster or slower than that of the flowing fluid.

14. A projector for projecting an image according to an input video signal, comprising:
the light source device according to claim 1;
a spatial modulation unit for modulating the illuminating beam radiated by the light emission unit according to the video signal; and
an optical projection unit for projecting the illuminating beam modulated by the special modulation unit.

15. The projector according to claim 13, wherein the manipulated variable is a zoom amount of the optical projection unit.

16. The projector according to claim 13, wherein the manipulated variable is a focus amount of the projection optical unit.

17. The projector according to claim 13, wherein the manipulated variable is an aperture of the projection optical unit.

18. The light source device according to claim 10, wherein the light emission unit is LEDs, the temperature of the light emission unit is a junction temperature of the LEDs or a temperature of a prescribed part of the light emission unit having a correlation with the junction temperature.
